(19) United States
(12) Patent Application Publication
(10) Pub. No.: US 2010/0221165 A1
(43) Pub. Date: Sep. 2, 2010

(54) OFF-GAS CATALYST FOR HYDROCHLORIC ACID-CONTAINING OFF-GASES

(75) Inventors: Ingo Hanke, Frankfurt (DE); Arno Tissler, Tegernheim (DE)

Correspondence Address: CONNOLLY BOVE LODGE & HUTZ LLP, 1875 EYE STREET, N.W., SUITE 1100, WASHINGTON, DC, 20006, US

(73) Assignee: Sud-Chemie AG, Munchen (DE)

(21) Appl. No.: 12/667,622

(22) PCT Filed: Jul. 2, 2008
(86) PCT No.: PCT/EP2008/005406

§ 371 Date: Apr. 27, 2010

(30) Foreign Application Priority Data
Jul. 3, 2007 (DE) 10 2007 030 895.9

(51) Int. Cl. B01D 53/56; B01J 38/42; B01J 29/04; B01J 29/072; B01J 29/18; B01J 29/08

(52) U.S. Cl. 423/239.2; 502/35; 502/60; 502/74; 502/78; 502/79

(57) ABSTRACT

The present invention relates to a process for reactivating a catalyst which comprises a zeolite doped with an iron species, which comprises the step of treating the catalyst with hydrogen chloride-containing gas. The invention further relates to a reactivated catalyst which is obtained with the aid of the process according to the invention and to the use thereof for treatment of off-gases from incineration processes, especially for the treatment of off-gases from refuse incineration plants, very particularly for the reduction of nitrogen oxides.

The present invention relates to a process for reactivating a catalyst which comprises a zeolite doped with an iron species, which comprises the step of treating the catalyst with hydrogen chloride-containing gas. The invention further relates to a reactivated catalyst which is obtained with the aid of the process according to the invention and to the use thereof for treatment of off-gases from incineration processes, especially for the treatment of off-gases frost refuse incineration plants, very particularly for the reduction of nitrogen, oxides.

Nitrogen oxides which form during incineration processes are among the main causes of acid rain and the environmental damage associated with this, and are triggers of the so-called summer smog which leads to health problems. Their emission should be prevented by their removal from the off-gases before these are released into the environment.

Principal sot-roes of the release of nitrogen oxide into the environment are motor vehicle traffic and incineration plants, in particular power stations with furnaces or stationary combustion engines, and also refuse incineration plants.

Because of the harmful effects of nitrogen oxide emissions on the environment, it is important to further reduce these emissions. Clearly lower NOₓ emission limits for stationary and motor vehicle off-gases than are customary today are planned for the near future in the United States and are also being discussed in the European Onion.

In order to observe these limits, in the case of mobile combustion engines(diesel engines) this can no longer be achieved by measures inside the engine, but only by an off-gas post-treatment, for example with suitable catalysts.

One of the most important techniques for removing nitrogen oxides is selective catalytic redaction (SCR). Hydrocarbons (HC—SCR) or ammonia (NH₃—SCR) or NH₃ precursors such as urea (Ad-Blue®) usually serve as reducing agents. Metal-exchanged zeolites (also called metal-doped zeolites) have proved to be very active SCR catalysts that can be used in a broad temperature range. They are in most cases non-toxic and produce less N₂O and SO₃ than the customary catalysts based on V₂O₅. In particular iron-doped zeolites represent good alternatives to the normally used vanadium catalysts, because of their high activity and resistance to sulphur under hydrothermal conditions.

Problems result from the thermal ageing of toe catalyst during operation or even already during the doping or introduction of active components, such as e.g. iron, vanadium, cobalt and copper, into the zeolite, since different oxidation states of these catalytically active metals are often present side by side and also the desired catalytically active species are not always obtained or the catalytically active species are converted into catalytically inactive species when the catalyst is operated at higher temperatures or daring the production process (oxygen, temperature, moisture, etc.).

It has been shown that in practically ail the known processes of the state of the art, cluster species of the catalytically active metals, which are catalytically inactive or the presence of which greatly reduces the catalytic activity, form as a result of the metal exchange inside the zeolite.

It has already long been attempted in the state of the art to additionally activate catalysts, prior to their use, in such a way that the presence of catalytically inactive species is avoided when possible.

Thus DE 38 41 990 discloses the use of molybdenum-containing Ca-coped zeolites which are used in particular when employed in flue gases from coal-fired furnaces. Processes for reactivating such catalysts for the denitrification of off-gases are likewise known and in most cases comprise the reduction of the de-activated catalysts or de-activated catalytically active species by means of treatment with hydrogen (U.S. Pat. No. 3,986,982).

U.S. Pat. No. 4,815,319 describes catalysts for producing 1,4-bis(4-phenoxybenzoyl) benzene, wherein the zeolitic catalyst is reactivated or activated by means of a combined hydrogen-HCl treatment.

EP 316 727 relates to the reactivation or noble metal-containing zeolites by means of a CCl₄/O₂/N₂ mixture, The nee of HCl is not recommended, as HCl produces poor results compared with CCl₄ and CFCl₂ and the reactivation is not complete.

By “clusters” are meant polynuclear bridged or unbridged metal compounds which contain at least throe identical or different metal atoms. Metal-exchanged zeolites in which no metal clusters were able to be detected inside one zeolite framework are so far unknown.

The object of the present invention was therefore to provide a further process in which the inactive metal species which, form through thermal ageing or during doping can be converted into active metal species.

This object is achieved by a process for reactivating a catalyst which comprises a zeolite doped with a metal species, which comprises the step of treating the catalyst with hydrogen chloride-containing gas, hydrogen chloride can be used pure or with a further gas such as e.g. N₂. However, the gas contains no it or organic chloride compounds such as CCl₄, CF₂Cl₂, etc. The catalyst can in particular also be treated with pure HCl gas.

Preferably, the metal, species comprises iron, cobalt, copper or vanadium, quite particularly preferably iron. The term “metal species”, as it is used here, is explained in more detail below. The zeolite is likewise free of noble metals, such as Pt, Pd, Rh, Ir, Ru, Os, Ag, Au.

The process according to the invention effects a conversion of the inactive metal species. The catalytically inactive clusters are converted into active species, i.e. after she conversion the metal-doped zeolite is substantially free of catalytically inactive or catalytically less active metal clusters, with the result, that only monomeric (isolated species in the form of individual metal atoms or metal cations) or dimeric catalytically highly active metal species are present in the pore structure or its framework, the structure of which is formed by the pores.

Dimeric species are isolated species comprising two metal atoms, wherein the metal atoms can either be bridged (e.g. via O atoms or an OH group) or unbridged, i.e. have a metal-metal bond. Typically, these are mixed oxo-hydroxo metal species, such as were described for example for iron in: M. Mauvetin et al., J. Phys. Chem. B 2001, 105, 928-935, or for other metals for example by Varga et al. in “Catalysis by Microporous Materials” Elsevier 1995, pp. 665-672.

The activity and selectivity of the catalytically active metal-doped zeolite is significantly increased by the process according to the invention compared with the known zeolites of the state of the art. It was found that generally, compared with the zeolites of the state of the art doped with the same metal in which, as explained above, in most cases metal clusters are present in the zeolite, thus where there was not treatment with HCl gas, the metal-doped zeolites show an increase in activity of approx. 30% for each metal during the reduction of NO to N₂. This is true in particular of zeolites containing Fe and Cu.

Inactive metal clusters also reduce she pore volume and impede gas diffusion or lead to undesired secondary reactions, which can likewise be advantageously prevented by the process according to the invention.

By “zeolite” is meant, within the framework of the present invention as defined by the International Mineralogical association (D. S. Coombs et al., Can. Mineralogist, 35, 1997, 1571), a crystalline substance from the group of the aluminosilicates with a spatial network structure of the general formula

Mⁿ⁺ₙ{(AlO₂)ₓ(SiO₂)_{y}}i^{t}H₂O

which consist of SiO₄/AlO₄ tetrahedra which are linked by common oxygen atoms to form a regular, three-dimensional network. The Si/Al=y/x ratio is always kg according to the so-called “Löwenstein Rule”, which states that two adjacent negatively-charged AlO₄ tetrahedra may not occur next to each other. Thus, although more exchange sites are available for metals with a low Si/Al ratio, the zeolite becomes increasingly thermally unstable.

The zeolite structure contains voids end channels which are characteristic of each zeolite. The zeolites are divided into different structural types (see above) according to their topology. The zeolite framework contains open voids in the form of channels and cages which, are normally occupied by water molecules and extra-framework cations which can be replaced. An aluminium atom attracts on excess negative charge which is compensated for by these cations. The inside of the pore system represents the catalytically active surface. The core aluminium and the leas silicon a zeolite contains, the denser the negative charge is in its lattice and the more polar its inner surface. The pore size and structure are determined, in addition to the parameters during production (use or type of templates, pH, pressure, temperature, presence of seed crystals), by the Si/Al ratio which determines the greatest part of the catalytic character of a zeolite. In the present case it is particularly preferred, if the molar Si/Al ratio of a zeolite according to the invention lies in the range from 10 to 20. This corresponds to an SiO₂/Al₂O₃ ratio of 20-40.

Because of the presence of 2- or 3-valent cations as tetrahedron centre in the zeolite framework the zeolite receives a negative charge in the form of so-called anion sites in the vicinity of which the corresponding cation positions are located. The negative charge is compensated for by incorporating cations into the pores of the zeolite material. Zeolites are differentiated mainly according to the geometry of the voids which are formed by the rigid network of the SiO₄/AlO₄-tetrahedra. The entrances to the voids are formed by 8, 10 or 12 “rings” (narrow-, average- and wide-pored zeolites). Specific zeolites show a uniform structure (e.g. ZSM-5 with MFI topology) with linear or zig-zag channels, while in others larger voids attach themselves behind the pore openings, e.g. in the case of the Y and A zeolites with the topologies FAU and LTA, Generally, 10- and 12-“ring” zeolites are preferred according to the invention.

In principle, any zeolite, in particular any 10- and 12-“ring” zeolite, can be used within the framework oil the present invention. Zeolites with the topologies AEL, BEA, CHA, EUO, ERI, FAU, FER, KFI, LTA, LTL, MAZ, MOR, MEL, MTW, LEV, OFF, TON and MFI are preferred according to the invention. Zeolites of the topological structures BEA, MFI, FER, MOP, MTW and ERI are quite particularly preferred.

It is preferred that the pore sizes of the zeolites used, in the process according to the invention lie in the range front 0.4 to 1.5 nm which, also because of the more favourable steric relationships for monomeric or dimeric metal species, contributes advantageously to the formation of mononumeric or dimeric metal species instead of metal clusters.

Typically, the metal content or the degree of exchange of a zeolite is decisively determined by the metal species present in the zeolite. As already stated above, the zeolite can be doped either with only a single metal or with different metals.

There are usually three different centres in zeolites, designated the so-called, α-, β- end γ-positions, which define the position of the exchange spaces (also called “exchangeable positions or sites”). All these three positions are available to reactance during the NH3-SCR reaction, in particular when using MFI, BEA, FER, MOR, MTW and ERI zeolites.

The so-called α-type cations show the weakest bond to the zeolite framework and are the last to be occupied in a liquid ion exchange. From a degree of exchange of around 10% the degree of occupancy increases markedly as the metal content increases and amounts to around 10 to 50% in total at a degree of exchange of up to M/Al=0.5. Cations at this site form very active redox catalysts.

On the other hand, the β-type cations which represent the most-occupied position and catalyse the HC-SCR reaction most effectively during liquid ion exchange, in particular with small degrees of exchange, display an average bonding strength to the zeolite framework. This position is filled immediately after the γ-position and, from a degree of exchange of around 10%, its degree of occupancy falls as the metal content increases and amounts to around 50 to 90% for a degree of exchange of up to M/Al=0.5. In the state of the art it is known that from a degree of exchange of M/Al>0.56 typically only polynuclear metal oxides are still deposited.

The γ-type cations are those with the strongest bond to the zeolite framework and thermally the most stable. They are the least-occupied position during liquid ion exchange, but are filled first. Cations, in particular iron and cobalt, in these positions are highly active and are the most catalytically active cations.

Preferred metals for the exchange and the doping within the framework of the present invention are catalytically active metals, such as Fe, Co, Cu, V and mixtures thereof, quite particularly preferably Fe, which also form bridged dimeric species, such as are present in the zeolite used in the process according to the invention in particular after the treatment.

Overall, the quantity of metal, calculated as corresponding metal oxide is 1 to 5 wt. -%, relative to the weight of the metal-doped zeolite. In the following, when the percentages by weight are relative to a metal oxide, the most stable metal oxides are meant every time, i.e. in the case of iron oxide Fe₂O₃ is meant. In particular it is preferred that more than 50% of the exchangeable sites (i.e. α-, β- and γ-sites) are exchanged. Quite particularly preferably, more than 70% of the exchangeable sites are exchanged. However, free sites should always still remain which are preferably Brønstedt acid centres. This is because NO is strongly absorbed both on the exchanged metal centres and also in ion-exchange positions or at Brønstedt centres of the zeolite framework. Moreover, NH₃ preferably reacts with the strongly acid Brønstedt centres, the presence of which is thus very important for a successful NH₃-SCR reaction.

The presence of free radical-exchange spaces and/or Brønstedt acid centres and the metal-exchanged lattice spaces is thus quite particularly preferred according to the invention. Therefore, a degree of exchange of 70-90% is most preferred. At a degree of exchange of more than 90%, a reduction in activity was observed during the reduction, of NO to N₂ and the SCR-NH₃ reaction.

Because of the danger of the hydrothermal deactivation of metal-doped zeolites, which is preceded by a dealuminization and migration of metal from the ion-exchange centres of the zeolite, it is preferred that the doping metals if at ail possible do not form a stable compound with aluminium, as a dealuminization is thereby promoted.

It is furthermore the object of the present invention to provide an activated, catalyst based on a metal-doped zeolite which has at its disposal catalytically active metal species which catalyse the selective catalytic reduction of nitrogen oxides during incineration processes.

According to the invention, the object is achieved by a catalyst which is produced by a process described above for reactivating a catalyst which contains a zeolite doped with a metal species, which would be treated with hydrogen chloride gas.

The effect of treating a metal-doped catalyst with hydrogen chloride gas is the conversion of the catalytically inactive metal clusters. During the conversion, the most widely differing metal species form which are catalytically active during the reductive conversion of nitrogen oxides.

The preferred metals of the metal species are the same as described above. The activity and selectivity of the catalysis depends decisively on the co-ordination of the metal species in the zeolite. Furthermore, the catalysis activity depends on the occupancy of the α- , β- and γ-positions, and the metal species. Surprisingly, it was found that the reaction of the ageing of the zeolites doped with a metal, which leads to a deactivation of the zeolite, and the reaction of the reactivation of the catalyst under the influence of HCl gas can maintain the balance. A precise explanation of the form in which the metal species are present and of how they influence the catalysis is difficult to specify.

According to the invention, the object is furthermore achieved by a catalyst for selective catalytic reduction, obtained by the above process according to the invention, containing a zeolite which contains a monomeric and/or dimeric species of a metal, wherein the catalyst has a pore volume of 0.35 to 0.7 ml/g, particularly preferably from 0.4 to 0.5 ml/g.

The catalyst according to the invention contains either monomeric or dimeric metal species, or monomeric and dimeric metal species. Here too, the preferred metal species are those described above. The basis of this solution to the problem underlying the invention is the surprising finding that zeolites containing inactive metal clusters can be converted into zeolites which contain catalytically active monomeric and/or dimeric metal species by being placed in contact with or exposed to gaseous hydrogen chloride. The subject of the teaching according to the invention is therefore catalysts for selective catalytic reduction from a zeolite which contains a metal species, which are obtained after bringing the zeolite containing metal into contact with gaseous hydrogen chloride. For the reaction with hydrogen chloride according to the process according to the invention to proceed at a sufficient, speed inside the zeolite, it is advantageous if the catalyst has the above-named pore volumes.

According to the invention, the metal species of the catalyst according to the invention is selected from iron, cobalt, cooper or vanadium or mixtures thereof, whereby iron species are particularly preferred.

The zeolite is advantageously selected from the zeolites of the structure types AEL, BEA, CHA, EUO, ERI, FAU, FER, KFI, LTA, LTL, MAZ, MOR, MEL, MTW, LEV, OFF, TON and MFI, in particular from the structure types BEA, MFI, FER, MOR, MTW and ERI. With these zeolite structure types, the conversion, of the hydrogen chloride gas can be carried out at sufficient reaction speeds.

In order to achieve sufficient reaction speeds of the conversion to be catalysed, the catalyst, i.e. the metal-doped zeolite present as powder for the selective catalytic reduction, has a BET surface area between 100 and 500 m²/g, preferably between 200 and 400 m²/g. For the same reasons, the pore size of the zeolite is between 0.4 and 1.5 nm.

In a particularly preferred embodiment of the catalyst according to the invention, the metal, in particular iron, is present in a quantity of 1 to 5 wt.-% calculated as metal oxide, relative to the total weight of the zeolite. On the one hand, as much metal as possible should be present in the catalyst, as the metal is the catalysing species, but on the other hand the number of occupancy sites in the catalyst is limited.

Furthermore, it is preferred that the catalyst tor the selective catalytic reduction is a 10- or 12-“ring” zeolite. A sufficient quantity of metal can be incorporated into this type of zeolite and the gases to be converted reach the active centres.

Furthermore, it is particularly preferred that, in the catalyst for the selective catalytic reduction, more than 50% of the exchangeable sites of the zeolite framework are occupied by metal, in particular iron, after the reactivation.

According to the invention, the catalysts are used for the treatment of off-gases, in particular for the reduction, of nitrogen oxides in off-gases from gasification and incineration processes. In particular, the catalysts are used for the treatment of off-gas from refuse incineration plants. As the catalyst is suitable in particular for use in the treatment of off-gases which contain acid constituents, the catalysts according to the invention can be used directly in plants where the off-gas from the incineration processes is not subjected to an acid wash.

1. Process for reactivating a catalyst which comprises a zeolite doped with a metal species, comprising the step of treating the catalyst with hydrogen chloride-containing gas.

2. Process according to claim 1, characterized in that the metal species is selected from iron, cobalt, copper or vanadium.

3. Process according to claim 1, characterized in that the metal species is iron.

4. Process according to claim 1, characterized in that the zeolite is selected from the zeolites of the structure types AEL, BEA, CHA, EUO, ERI, FAU, FER, KFI, LTA, LTL, MAZ, MOR, MEL, MTW, LEV, OFF, TON and MFI, in particular from the structure types BEA, MFI, FER, MOR, MTW and ERI.

5. Process according to claim 4, characterized in that the pore size of the zeolite is 0.4 to 1.5 nm.

6. Process according to claim 5, characterized in that the metal is present in a quantity of 1 to 5 wt.-% calculated as metal oxide, relative to the total weight of the zeolite.

7. Process according to claim 1, characterized in that the zeolite is a 10- or 12-“ring” zeolite.

8. Process according to claim 1, characterized in that more than 50% of the exchangeable sites of the zeolite framework are occupied by metal species, after the reactivation.

9. Reactivated catalyst for the selective catalytic reduction of nitrogen oxides, produced according to a process according to claim 1.

10. Reactivated catalyst according to claim 9 containing a zeolite which contains a monomeric and/or dimeric species of a metal, wherein the catalyst has a pore volume of 0.35 to 0.7 ml.

11. Reactivated catalyst according to claim 10, characterized in that the metal species is selected from iron, cobalt, copper or vanadium.

12. Reactivated catalyst according claim 10, characterized in that the zeolite is selected from the zeolites of the structure types AEL, BEA, CHA, EUO, ERI, FAU, FER, KFI, LTA, LTL, MAZ, MOR, MEL, MTW, LEV, OFF, TON and MFI, in particular from the structure types BEA, MFI, FER, MOR, MTW and ERI.

13. Reactivated catalyst according to claim 10, characterized in that the BET surface area of the catalyst is 100 to 500 m²/g.

14. Reactivated catalyst according to claim 10, characterized in that the pore size of the zeolite is 0.4 to 1.5 nm.

15. Reactivated catalyst according to claim 10, characterized in that the metal is present in a quantity of 1 to 5 wt.-% calculated as metal oxide, relative to the total weight of the zeolite.

16. Reactivated catalyst according to claim 10, characterized in that the zeolite is a 10- or 12-“ring” zeolite.

17. Reactivated catalyst according to claim 10, characterized in that more than 50% of the exchangeable sites of the zeolite framework are occupied by iron after the reactivation.

18. Method of treating off-gases from gasification and incineration processes using a reactivated catalyst according to claim 9, comprising converting an inactive metal species into an active metal species.

19. Method according to claim 18 for the reduction of nitrogen oxides in off-gases from gasification and incineration processes.

20. Method according to claim 18 for the treatment of off-gas from refuse incineration plants.

21. Method according to claim 18, characterized in that the catalyst is actuated prior to an acid wash.
